(19) United States
(12) Patent Application Publication
(10) Pub. No.: US 2023/0246289 A1
(43) Pub. Date: Aug. 3, 2023

(54) BATTERY SYSTEM WITH ACTIVE COOLING OF VENTING CHANNEL

(71) Applicant: SAMSUNG SDI CO., LTD., Yongin-si (KR)

(72) Inventors: Andreas Pröll, Helfenberg (AT); Matthias Pucher, Ragnitz (AT)

(21) Appl. No.: 18/104,495

(22) Filed: Feb. 1, 2023

(30) Foreign Application Priority Data
Feb. 1, 2022 (EP) 22154549.4
Jan. 31, 2023 (KR) 10-2023-0013172

(51) Int. Cl. H01M 50/358; H01M 50/209; H01M 50/502; H01M 50/291; F28F 3/12; B60L 50/64

(52) U.S. Cl. CPC H01M 50/358; B60L 50/64; F28F 3/12; H01M 50/209; H01M 50/291; H01M 50/502; B60L 58/26; H01M 2220/20

(57) ABSTRACT

A battery system includes: a battery pack including a plurality of battery cells; a venting device configured to guide a venting gas stream exhausted by one or more of the battery cells away therefrom; and a cooling device. The venting device includes: a venting channel configured to guide the venting gas stream along a main flow direction, the venting channel being delimited by a first side of the venting device and a second side of the venting device opposite the first side; and a venting opening in the first side of the venting device to allow venting gases to enter the venting channel. The cooling device includes a first cooling channel at the first side of the venting device and configured to cool the venting channel via a cooling fluid flowing through the first cooling channel.

### CROSS REFERENCE TO RELATED APPLICATION

This application claims priority to and the benefit of European Patent Application No. 22154549.4, filed in the European Patent Office on Feb. 1, 2022, and Korean Patent Application No. 10-2023-0013172, filed in the Korean Intellectual Property Office on Jan. 31, 2023, the entire content of which is incorporated herein by reference.

### 1. Field

Aspects of embodiments of the present disclosure relate to a battery system with active cooling of a venting channel.

### BACKGROUND

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery’s intended purpose. Lithium-ion (and similar lithium polymer) batteries, widely known via their use in laptops and consumer electronics, dominate the most recent electric vehicles in development.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

A battery system may also include a battery management system (BMS), which is any suitable electronic system that is configured to manage the rechargeable battery, battery module, and battery pack, such as by protecting the batteries from operating outside their safe operating area, monitoring their states, calculating secondary data, reporting that data, controlling its environment, authenticating it, and/or balancing it. For example, the BMS may monitor the state of the battery as represented by voltage (e.g., a total voltage of the battery pack or battery modules and/or voltages of individual cells), temperature (e.g., an average temperature of the battery pack or battery modules, coolant intake temperature, coolant output temperature, and/or temperatures of individual cells), coolant flow (e.g., flow rate and/or cooling liquid pressure), and current. Additionally, the BMS may calculate values based on the above parameters, such as minimum and maximum cell voltage, state of charge (SOC) or depth of discharge (DOD) to indicate the charge level of the battery, state of health (SOH; a variously-defined measurement of the remaining capacity of the battery as % of the original capacity), state of power (SOP; the amount of power available for a defined time interval given the current power usage, temperature and other conditions), state of safety (SOS), maximum charge current as a charge current limit (CCL), maximum discharge current as a discharge current limit (DCL), and internal impedance of a cell (to determine open circuit voltage). The BMS may be centralized such that a single controller is connected to the battery cells through a multitude of wires. In other examples, the BMS may be distributed, with a BMS board installed at each cell, with just a single communication cable between the battery and a controller. In yet other examples, the BMS may have a modular construction including a few controllers, each handling a certain number of cells while communicating between the controllers. Centralized BMSs are most economical but are least expandable and are plagued by a multitude of wires. Distributed BMSs are the most expensive but are simplest to install and offer the cleanest assembly. Modular BMSs provide a compromise of the features and problems of the other two topologies.

A BMS may protect the battery pack from operating outside its safe operating area. Operation outside the safe operating area may be indicated by overcurrent, over-voltage (during charging), over-temperature, under-temperature, overpressure, and ground fault or leakage current detection. The BMS may prevent the battery from operating outside its safe operating parameters by including an internal switch (e.g., a relay or solid-state device) that opens if the battery is operated outside its safe operating parameters, requesting the devices to which the battery is connected to reduce or even terminate using the battery, and actively controlling the environment, such as through heaters, fans, air conditioning or liquid cooling.

An active or passive thermal management system to provide thermal control of the battery pack is often included to safely use the at least one battery module by efficiently emitting, discharging, and/or dissipating heat generated from its rechargeable batteries. If the heat emission, discharge, and/or dissipation is not sufficiently performed, temperature deviations may occur between respective battery cells, such that the battery module may no longer generate a desired (or designed) amount of power. In addition, an increase of the internal temperature can lead to abnormal reactions occurring therein, and thus, charging and discharging performance of the rechargeable deteriorates and the life-span of the rechargeable battery is shortened. Thus, cell cooling for effectively emitting, discharging, and/or dissipating heat from the cells is important.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. These exothermic reactions include combustion of flammable gas compositions within the battery housing. For example, when a cell is heated above a critical temperature (typically above about 150° C.), the cell can transition into a thermal runaway. The initial heating may be caused by a local failure, such as a cell internal short circuit, heating from a defective electrical contact, or short circuit to a neighboring cell. During the thermal runaway, a failed battery cell, such as a battery cell that has a local failure, may reach a temperature exceeding about 700° C. Further, large quantities of hot gas are ejected (or emitted) from inside of the failed battery cell through the venting opening in the battery housing into the battery pack. The main components of the vented gas are H₂, CO₂, CO, electrolyte vapor, and other hydrocarbons. The vented gas is therefore flammable and potentially toxic. The vented gas also causes a gas-pressure to increase inside the battery pack.

A related art venting concept of a battery is to let the hot venting gas stream from a battery cell in a thermal runaway condition expand into the battery housing and escape through a housing venting valve to the outside (e.g., to the environment of the battery housing). The venting gas stream may include hot and toxic venting gas as well as conductive solid matter (e.g., material), such as graphite powder and metal fragments. The electrically conductive material may deposit on electrically active parts, such as terminals and busbars on top of the cells, causing short circuits and arcing. Thus, the thermal runaway of one battery cell could cause short circuits and, thus, a consecutive thermal runaway of other battery cells leading into a complete damage or deconstruction of the battery (e.g., the battery pack), the battery system, and the vehicle.

To prevent this, a venting device may be provided to cover the venting side of the battery cells, and the venting device may include a venting channel to direct (e.g., to lead) the venting gas stream away from the battery cells to the outside without contacting the electrically active parts of the cells. However, there is a risk of deflagration of the venting gas at the housing venting valve, which may lead to damage of external components, and which is a risk for any bystanders or service personnel.

### SUMMARY

According to embodiments of the present disclosure, at least some of the drawbacks of the related art are mitigated or overcome by providing improved thermal runaway handling, in particular, by better protecting a battery system against the venting products exhausted during a thermal runaway, and which is safer for bystanders.

The present disclosure is defined by the appended claims and their equivalents. Any disclosure lying outside the scope of the claims and their equivalents is intended for illustrative as well as comparative purposes.

According to an embodiment of the present disclosure, a battery system includes a battery pack including a plurality of battery cells, a venting device configured to guide a venting gas stream exhausted by one or more of the battery cells away from the battery cells along a main flow direction, and a cooling device. The venting device includes a venting channel for guiding the venting gas stream, the venting channel being delimited by a first side of the venting device and a second side of the venting device opposite the first side, and one or more venting openings in the first side of the venting device for allowing the venting gases exhausted by the battery cells to enter the venting channel. The cooling device includes one or more cooling channels for cooling the venting channel via cooling fluid transported (or flowing) through the cooling channels, and at least one of the cooling channels is arranged at the second side of the venting device.

According to another embodiment of the present disclosure, an integrated venting and cooling device includes a venting channel for guiding a venting gas stream, the venting channel being delimited by a first side of the integrated venting and cooling device and a second side of the integrated venting and cooling device opposite the first side, and one or more venting openings arranged at the first side of the integrated venting and cooling device for allowing the venting gases exhausted by the battery cells to enter the venting channel. The integrated venting and cooling device further includes one or more cooling channels, and at least one of the cooling channels is arranged at the second side of the venting device opposite the first side for cooling the venting channel via cooling fluid transported through the cooling channels.

Yet another embodiment of the present disclosure provides an electric vehicle including a battery system as described above.

Further aspects and features of the present disclosure can be learned from the dependent claims or the following description. Explanations given and aspects described below with respect to the battery system apply correspondingly to the single unit venting and cooling device and vice versa.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic side view of a battery system according to an embodiment.

FIG. 2 is a perspective view of the battery system shown in FIG. 1.

FIG. 3 is a perspective view of the battery system shown in FIG. 1.

FIG. 4 is a perspective view of the battery system shown in FIG. 1.

FIG. 5 is a perspective cross-sectional view of the battery system shown in FIG. 1.

FIG. 6 is a perspective view of the battery system shown in FIG. 1.

FIG. 7 is a schematic side view of a battery system according to another embodiment.

FIG. 8 is a perspective view of a single unit venting and cooling device according to an embodiment.

FIG. 9 is a cross-sectional view of the single unit venting and cooling device shown in FIG. 8.

FIG. 10 is a cross-sectional view of a single unit venting and cooling device according to an embodiment.

FIG. 11 is a cross-sectional view of a single unit venting and cooling device according to an embodiment.

### DETAILED DESCRIPTION

Reference will now be made in detail to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments described herein. Rather, these embodiments are provided as examples so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially,” “about,” and similar relative terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of +/- 5% of the value centered on the value.

Herein, the terms “upper” and “lower” are defined according to the z-axis in the figures. For example, the upper layer of battery cells is positioned at the upper part of the z-axis, whereas the lower layer of battery cells is positioned at the lower part thereof. It will be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

In the drawings, the sizes of elements may be exaggerated for clarity. For example, in the drawings, the size or thickness of each element may be arbitrarily shown for illustrative purposes, and thus, embodiments of the present disclosure should not be construed as being limited thereto.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery system includes a battery pack including a plurality of battery cells. The battery cells may be interconnected (e.g., may be connected to each other) via busbars contacting respective electrode terminals of the battery cells to form one or more battery modules. The battery cells may be, for example, prismatic or cylindrical cells. The battery cells have venting exits at a venting side of the battery cells, which is, in one embodiment, the terminal side of the battery cells. The venting exits allow a venting gas stream to escape the battery cells during a thermal runaway. Venting valves may be provided at (or in) the venting exits.

The battery system further includes a venting device arranged at the venting side of the battery cells. The venting device includes a venting channel for guiding the venting gas stream escaping from the battery cells during a thermal runaway away from cells along a main flow direction towards a system exit so that the venting gas stream may escape to the outside/environment of the battery system or vehicle. The venting channel may be delimited by (e.g., may be formed by) channel walls of the venting device. A first side of the venting device may form a first channel wall and a second side of the venting device opposite the first side may form a second channel wall. The venting channel may extend between the first and second side. The venting device comprises one or more venting openings for allowing the venting gases exhausted by the battery cells to enter the venting channel. The venting openings in the venting device may be aligned with the venting exits of the battery cells.

In other embodiments, the first channel wall of the first side of the venting device is formed by the cell surface of the battery cell to which the venting device is attached. In other words, the venting channel may be delimited by (e.g., may be formed by) a channel wall of the venting device on one side and by the venting side of the battery cells on the opposite side. In such an embodiment, the venting exits of the battery cells form the venting openings in the venting device. The venting device receives and encapsulates the whole (or entire) venting gas stream, thereby protecting any electrically live parts, such as the terminals of the battery cells and the busbars. The venting openings are arranged at the first side of the venting device, for example, in the first channel wall. The first side of the venting device is arranged opposite the venting side of the battery cells or may be formed by the venting side of the battery cells.

The battery system may further include a cooling device including one or more cooling channels for cooling the venting channel via cooling fluid transported through the cooling channels. At least one of the cooling channels is arranged at the second side of the venting device opposite the first side. For example, the cooling device includes at least one cooling channel, and the at least one cooling channel is arranged at the second side or second channel wall of the venting device. Because the first side or first channel wall is arranged at or formed by the venting side of the battery cells and, thus, the venting exits of the battery cells, the second side or second channel wall is arranged at a distance from the venting channel from the venting side of the battery cells and, thus, the venting exits of the battery cells. For example, because the first and second side of the venting device are distanced from (e.g., are spaced apart from) one another by the venting channel, the cooling channel is distanced from the venting openings by the venting channel as well. The cooling channel is, thus, arranged opposite the venting openings at the other end of the venting channel. The cooling channel may extend in a direction along the venting channel. For example, the venting channel and the cooling channel may extend longitudinally along a longitudinal axis. The cooling fluid may be transported along the length of the venting channel, for example, from one end of the venting device to an opposite end of the venting device, which allows for longer contact between the cooling fluid and the outer wall of the venting channel and, therefore, better heat transfer.

The cooling channel(s) may be arranged in contact with an outer wall of the venting channel, for example, with the second channel wall, so that heat may be transferred from the venting gas to the second channel wall of the venting channel to a cooling channel wall of one or more of the cooling channels and then to a cooling fluid flowing along the cooling channels. An inner side of the venting channel wall may delimit the venting channel, and an outer side of the venting channel wall may delimit at least a part of (or a portion of) one or more of the cooling channels, thus, forming part of the cooling channel walls. The cooling fluid may be a phase-changing fluid, for example, a water-glycol composition. By using a phase-changing fluid, the wall temperature of the fluid channel can be maintained under a certain temperature (e.g., about 130° C.) by controlled evaporation (of the water phase in case of a water-glycol composition).

The cooling channel actively cools the second side of the venting device. In the event of a thermal runaway, the venting gas stream enters the venting channel at the first side of the venting device through the venting openings, crosses at least a part of the venting channel, and comes into contact with the opposite second side of the venting device. The venting gas stream, thus, transfers heat to the second side. As the second side is actively cooled, the venting gas stream is cooled as well. As a result, the damaged battery cell that is experiencing a thermal runaway is further cooled to ensure its mechanical integrity by removing additional heat from this region. This cooling reduces temperatures in this region and, hence, heat transfer to neighboring cells. Therefore, a chance of a chain reaction of thermal runaways is reduced. Also, a meltdown of the venting side surface of the battery cells is prevented or delayed. Further, the venting gas stream is significantly cooled before reaching the system outlet and leaving the battery system so that deflagration at the outlet of the battery housing is prevented. Thus, the risk of damage of external components and of injury of any bystanders is reduced.

According to an embodiment of the present disclosure, the cooling device includes a plurality of cooling channels surrounding (e.g., extending around) the venting channel for cooling the venting channel via cooling fluid transported through the cooling channels. At least one from among the plurality of cooling channels is arranged at the second side of the venting device. The cooling channels surrounding the venting channel means that the cooling channels are arranged at multiple sides of the venting channel. For example, cooling channels may be arranged at the first side facing the venting side of the battery cells and at the second side opposite the first side. The venting side may be a terminal side of the battery system, that is, the side at which the electrical terminals of the battery cells and the busbars connecting the terminals are arranged. Thus, the venting device and the cooling device may be arranged at a terminal side of the battery cells.

According to an embodiment of the present disclosure, the cooling channel may surround all sides of the venting channel. In such an embodiment, the cooling channels may be provided at all four sides of the venting channel. The cooling device may encompass the venting channel or the venting device. By providing multiple cooling channels surrounding the venting channel, uniform cooling of the venting device, such as the venting channel walls, from all sides and not only from one side is provided, which also ensures the structural integrity of the venting channel. The venting and cooling device (e.g., the integral venting and cooling device) configured to liquid cool the venting gas provides superior venting gas management.

The cooling channel, thus, actively cools the second side of the venting device at the region around the venting channel, thereby cooling the venting gas stream flowing through the venting channel. As a result, the damaged cell that is experiencing a thermal runaway is further cooled to ensure its mechanical integrity by removing additional heat from this region. This reduces temperatures in this region and, hence, heat transfer to neighboring cells. Therefore, a chance of a chain reaction of thermal runaways is reduced. Also, a meltdown of the venting side surface of the battery cells is prevented or delayed. Further, the venting gas stream is significantly cooled before reaching the system outlet and leaving the battery system so that deflagration at the outlet of the battery housing is prevented. This reduces the risk of damage of external components and the risk of injury of any bystanders.

According to embodiments of the present disclosure, a cooled venting channel with at least one cooling channel is on the venting opening of the battery cell. The cooling channel(s) are separated from the venting channel so that there is no fluid exchange between the cooling channel(s) and the venting channel. In this manner, no cooling fluid can enter the venting channel and no venting gases can enter the cooling channel(s). The venting gas stream is discharged in a controlled manner and cooled in the process. This arrangement of the cooling channels allows for uniform cooling of the venting device, such as the venting channel walls, from all sides and not only from one side, which also ensures the structural integrity of the venting channel. The (single unit) venting and cooling device liquid cools the venting gas, thus, provides superior venting gas management.

The venting device may include the cooling device. For example, the one or more cooling channels may be part of (e.g., may be integral with) the venting device, or the venting device and the cooling device may form a venting and cooling device. According to an embodiment of the present disclosure, the venting device and the cooling device form a single unit. In other words, the venting device and the cooling device are formed together as one-piece. The single unit including the venting device and the cooling device may be formed together in a common or joined during production. Being formed as a single unit may mean an integral connection that cannot be non-destructively released. This way, the venting device and the cooling device and, thus, the one or more cooling channels and the venting channel may be simultaneously (or concurrently) manufactured in an efficient manner and integrally with direct contact between the walls of the one or more cooling channels and the venting channels. For example, the one or more cooling channels may be separated from the venting channel by a single channel wall. As described above, a first side of this channel wall may form an inner side of the one or more cooling channels and a second side of this channel wall opposite the first side may form an inner side of the venting channel. Such a single unit venting and cooling device allows for not only easier manufacture but also for a better heat transfer between the venting channel and the one or more cooling channels and, thus, for more effective cooling of the venting gas stream. The cooling device, in particular the single unit venting and cooling device, may be modified to be a load carrying component (e.g., a structural component) of the housing structure of the battery system.

According to an embodiment of the present disclosure, the venting device and the cooling device are formed by extrusion (e.g., may be formed as an extrusion profile). Thus, the venting device and the cooling device may be formed as a single unit via extrusion of a material, such as aluminum. Such an (aluminum) extrusion profile is relatively easy to manufacture and allows for the venting device and the cooling device and, thus, the venting channel and the one or more cooling channels, to be formed together in a single production step. An inner profile (or inner surface) of the single unit (or integral) venting and cooling device may delimit the venting channel, and an outer profile (or outer surface) surrounding the inner profile may delimit the one or more cooling channels. The inner profile and the outer profile may be integrally connected with one another, that is, may form a connection that cannot be non-destructively released. For example, the one or more cooling channels may be formed between the inner profile and the outer profile. This allows for a particularly efficient production of the single unit venting and cooling device with direct contact between the channel walls of the venting channel and the one or more cooling channels.

According to an embodiment of the present disclosure, an end plate is arranged at the longitudinal end of the single unit venting and cooling device. The end plate closes the venting channel, and one or more venting outlets are arranged in the channel wall of the venting channel near the longitudinal end of the venting channel to allow the venting gas stream to exit the venting channel perpendicular to the main flow direction. When producing the single unit venting and cooling device in a single production step, in particular via extrusion, the venting channel and the one or more cooling channels are open at both ends. The open end of the venting channel, according to this embodiment, is closed by arranging the end plate at the open end. The end plate may be press formed or (laser-)welded to the end of the venting channel. Venting outlets are provided to let the venting gas stream exit the venting channel at a position away from the battery cells. The venting outlets may be formed after the extrusion process by, for example, milling or punching. The venting outlets may be provided such that the venting gas stream is directed away from the main flow direction. For example, the venting outlets may be provided at a lower side of the venting channel to let the venting gas stream escape downwardly. This embodiment allows for a simple manufacture of the venting channel.

According to an embodiment of the present disclosure, an end cover element is arranged at the longitudinal end of the single unit venting and cooling device. The end cover element covers the end plate and the one or more cooling channels, and the end cover element is configured to allow supply of cooling fluid to the one or more cooling channels. All of the one or more cooling channels may be covered at their longitudinal end by the end cover element. In one embodiment, all of the cooling channels may be covered by the end cover element at once. The end cover element may be fixed at the outer profile of the single unit venting and cooling device by, for example, screws or a snap-fit connection. The end cover element provides a space and a supply line for supplying the cooling fluid to all of the cooling channels. The cooling fluid supplied by the end cover element splits into separate streams, one stream per cooling channel. The end plate closes the venting channel to prevent any cooling fluid from entering the venting channel. This relatively simple arrangement provides efficiently supply of the cooling fluid to all of the one or more cooling channels without the risk of cooling fluid entering the venting channel. Of course, in some embodiments, an end cover element may be provided which covers only the cooling channel. This way, two separate end elements may be provided for the venting channel and the one or more cooling channels.

According to an embodiment of the present disclosure, two cooling channels from among the cooling channels extend along the first side of the venting device, and the one or more venting openings are arranged between the two cooling channels. For example, at least two cooling channels may be arranged between the battery cells and the venting channel. The venting gas stream leaves (e.g., moves away from) one or more battery cells through the venting openings and may enter the venting channel bypassing (e.g., without entering) the two cooling channels. Thus, the venting gas stream may reach the venting channel although cooling channels are arranged at the first side. The two cooling channels extend along the first side of the venting device, and thus, the surface of the battery cells are arranged at the venting side of the battery cells and are in contact with the battery cells. Thus, the cooling device/cooling channels may also directly cool the venting side of the battery cells.

According to an embodiment of the present disclosure, one or more of the cooling channels are formed by grooves extending into the venting channel. For example, one or more of the cooling channels may be formed by grooves or indentations in a channel wall delimiting (or forming) the venting channel, and the grooves or indentations extend into the venting channel. The at least one cooling channel may be formed in the second side or second channel wall of the venting device. Because the grooves in the channel wall delimiting the venting channel may be uneven, the grooves may extend into the venting channel such that the venting channel is constricted or narrowed, thereby reducing the cross-section of the venting channel. The inner side of such a groove forms part of the inner side of the channel wall of the venting channel to contact the venting gas stream, and the outer side of such a groove forms part of a cooling channel to contact the cooling fluid. This allows for particularly effective cooling of the venting gas stream. Also, such an arrangement may be easily produced as an extrusion profile. Furthermore, such grooves form the cross-section of the venting channel. Thus, the grooves in the venting channel can be designed so that the venting gas stream primarily flows through specific regions.

According to an embodiment of the present disclosure, a gas splitting projection is arranged inside the venting channel opposite the one or more venting openings. The gas splitting projection is configured to split the gas stream entering the venting channel through one of the venting openings such that the gas stream is deflected to opposite sides of the venting channel. The gas splitting projection or protrusion may form part of the second channel wall delimiting the venting channel. The gas splitting projection may split the venting gas stream in two sub-streams (e.g., two smaller streams) flowing along opposite directions perpendicular to a longitudinal extension of the venting channel. The gas splitting projection may be formed by one of the grooves extending into the venting channel. The groove may provide a cooling channel and may provide the gas splitting projection.

The one or more venting openings are, in one embodiment, arranged in the middle of the venting channel so that the venting gas stream may enter the venting channel in its middle section and may be split into two sub-streams by the gas splitting projection. The two streams are deflected to opposite sides or outer areas of the venting channel. The gas splitting projection thus allows for a more even distribution of the venting gas stream, in particular, along a width of the venting channel, for example, in directions perpendicular to a longitudinal extension of the venting channel. This allows for more effective distribution of the venting gases within the venting channel and, thus, for more effective cooling.

According to an embodiment of the present disclosure, the battery system includes busbars interconnecting the battery cells via their terminals. The busbars are thermally connected to the cooling device. As described above, the electrode terminals of the battery cells may be interconnected via busbars. These busbars may act as heat bridges from one battery cell to another (e.g., to an adjacent battery cell) during a thermal runaway. According to this embodiment, the busbars are cooled by the cooling device so that excessive heat transfer from the damaged cell to the neighboring cells via the busbars is mitigated or prevented. According to an embodiment of the present disclosure, two busbar cooling channels from among the plurality of cooling channels are arranged at opposite longitudinal sides of the venting channel, and the two busbar cooling channels are thermally connected to the busbars. For example, the (single unit or integral) venting and cooling device includes two cooling channels, one at each side end, that extend along the main flow direction above the busbars. Thus, separate cooling channels may be provided to cool the busbars. These busbar cooling channels also surround the venting channel, thereby cooling the venting gas stream. Similar to the other cooling channels, the busbar cooling channels may be part of the single unit venting and cooling device and may be manufactured via extrusion.

According to an embodiment of the present disclosure, the plurality of battery cells includes layers of battery cells stacked on one another. The venting channel is arranged between a first layer and a second layer of the battery cells with the venting channel connected to the venting exits of at least one of the first and second layers of battery cells. A first side of the venting device is in thermal contact with or formed by the battery cells of the first layer, and a second side of the venting device is in thermal contact with battery cells of the second layer. For example, the venting and cooling device, including the single unit (or integral) venting and cooling device, may cool two adjacent layers of battery cells concurrently or simultaneously. For example, the venting channel may receive and lead (or direct or move) the venting gases of both of these layers of battery cells away from the battery cells. This arrangement is space saving and efficient.

According to an embodiment of the present disclosure, a separator element including a cooling channel extends vertically from the venting device, such as from the single unit venting and cooling device. The separator element extends into a gap between two adjacent battery cells of the second layer, thereby separating these battery cells. For example, the (single unit) venting and cooling device may be arranged at a top side of a lower layer of battery cells, and the separator element may extend upwardly therefrom into a gap between two battery cells of an upper layer of battery cells. The battery cells of the first and second layer are offset from one another so that the separator element may extend into the gap. The separator element separates and cools the neighboring cells of the upper layer due to the cooling fluid flowing along the cooling channel of the separator element. According to an embodiment, the cooling device, such as the single unit venting and cooling device, may be modified to simultaneously (or concurrently) act as bottom and/or side cooler in a multi floor design.

Embodiments of the present disclosure also provide an electric vehicle including a battery system as described above. The electric vehicle may include the battery system as a traction battery.

Embodiments of the present disclosure provide a single unit (or integral) venting and cooling device including a venting channel for guiding a venting gas stream, one or more venting openings for allowing the venting gases exhausted by the battery cells to enter the venting channel, and a plurality of cooling channels surrounding (e.g., extending around) the venting channel for cooling the venting channel via a cooling fluid passing through the cooling channels. The single unit venting and cooling device may be manufactured via an extrusion process and may be formed by, for example, an (aluminum) extrusion profile. For example, the single unit venting and cooling device may be formed by an extrusion profile including an inner profile forming the venting channel and an outer profile forming the cooling channels. The first side of the single unit venting and cooling device may be formed by a venting side of one or more battery cells that the single unit venting and cooling device is attached to. Further aspects, features, and details of the single unit venting and cooling device have been described above with respect to the battery system.

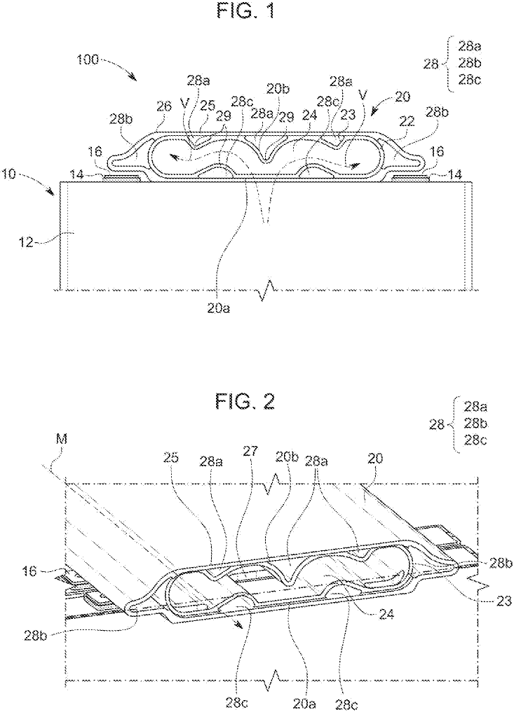

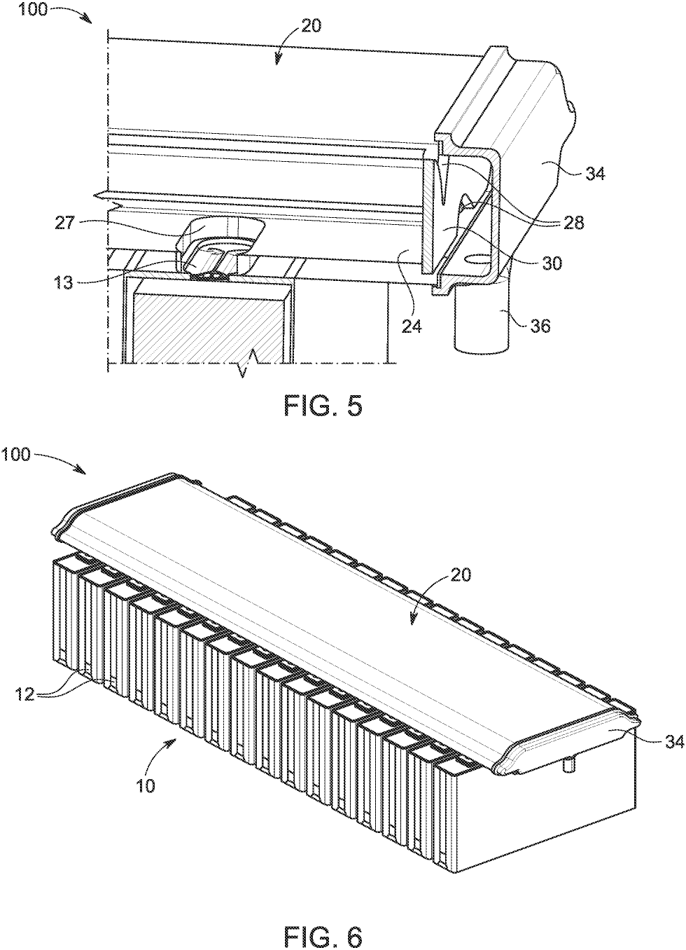

FIGS. 1 to 6 show a battery system 100 according to an embodiment of the present disclosure. The battery system 100 includes a battery pack 10 including a plurality of battery cells 12 and a single unit venting and cooling device (e.g., an integral venting and cooling unit) 20 arranged at a venting and terminal side of the battery cells 12. The battery cells 12 include electrode terminals 14 interconnected with one another via busbars 16 to form battery modules. The single unit venting and cooling device 20 includes a venting device 22 including a venting channel 24 and a cooling device 26 including a plurality of cooling channels 28 surrounding (e.g., extending around) the venting channel 24. The venting channel 24 is delimited by (e.g., formed by) a first side 20a of the single unit venting and cooling device 20 and by a second side 20b of the single unit venting and cooling device 20 opposite the first side 20a. Venting gas streams exiting the battery cells 12 at the venting exits 13 during, for example, a thermal runaway may enter the venting channel 24 via venting openings 27 arranged in the first side 20a. One of the venting openings 27 is shown in, for example, FIG. 2. The venting openings 27 are aligned with the venting exits 13 of the battery cells 12 as can be seen in, for example, FIG. 5. Three cooling channels (e.g., second cooling channels) 28a from among the plurality of cooling channels 28 are arranged opposite the venting openings 27 at the second side 20b of the single unit venting and cooling device 20.

The first side 20a is, however, not necessarily formed by a wall member of the single unit venting and cooling device 20 but may be, in another embodiment, formed by the cell surface of the battery cell 12 to which the single unit venting and cooling device 20 is attached. In such an embodiment, the venting side of the battery cells 12 may be understood as the first side 20a of the single unit venting and cooling device 20. In such an embodiment, the venting exits 13 of the battery cells 12 form the venting openings 27.

The venting device 22 and the cooling device 26 are formed together (e.g., are integrally formed) via an extrusion process. For example, the single unit venting and cooling device 20 is, in one embodiment, an aluminum extrusion profile. An inner profile 23 of the single unit venting and cooling device 20 forms a venting channel wall delimiting the venting channel 24, and an outer profile 25 thereof forms the cooling channels 28. The cooling channels 28 are arranged directly at the outer surface of the inner profile 23 and are, thus, delimited at one side by the inner profile 23 and on the other side by the outer profile 25. The inner profile 23 has a curved shape with a plurality of grooves 29 extending into the venting channel 24, and the grooves 29 form the cooling channels 28. For example, at least some of the cooling channels 28 extend (or protrude) into the venting channel 24. The outer profile 25 has a more even (e.g., flatter) shape, allowing better surface contact with the battery cells 12. Thus, at least the side of the outer profile 25 that is adjacent the venting side of the battery cells 12 may be even (or flat or substantially flat).

Two cooling channels (e.g., first cooling channels) 28c extend along a surface of the battery cells 12, and the venting openings 27 are arranged between the two cooling channels 28c. A venting gas stream V emitted from the battery cells 12 may enter the venting channel 24 through the venting openings 27, thereby passing the cooling channels 28c. The venting gas stream V then flows to the opposite second side 20b at where the cooling channel 28a is arranged. The groove 29 of a middle cooling channel 28a from among the three cooling channels 28a acts as a gas splitting (or diverting) projection opposite the venting openings 27, and the gas splitting projection splits (or divides) the venting gas stream V entering the venting channel 24 through one of the venting openings 27 such that the gas stream is deflected to opposite longitudinal sides of the venting channel 24 as can be seen in, for example, FIG. 1. Thus, the venting gas stream V is evenly (or substantially evenly) distributed along the width of the venting channel 24.

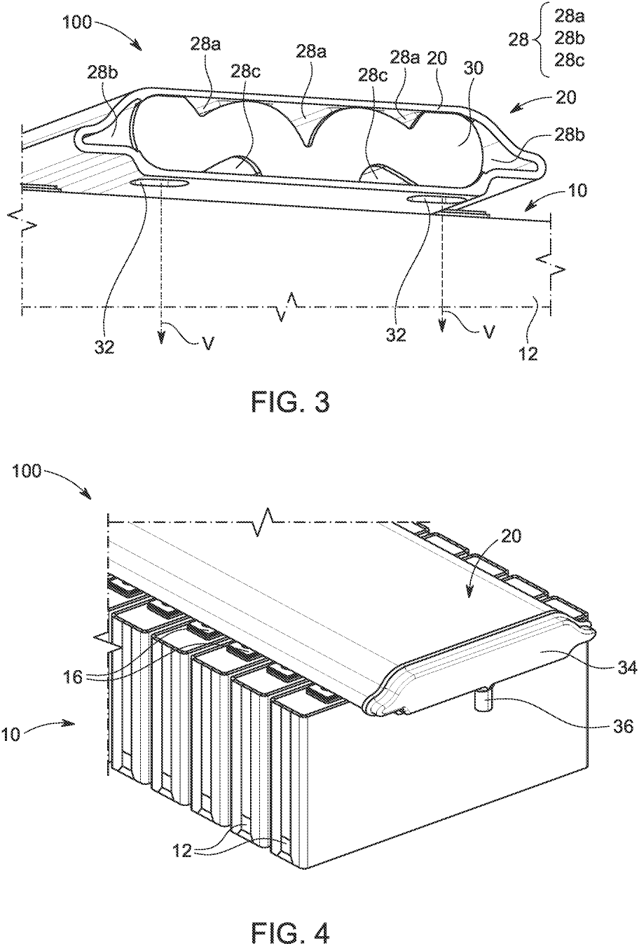

Subsequently, the venting gas stream V is guided along a main flow direction M along a longitudinal extension of the venting channel 24 towards an end side of the venting channel 24 (see, e.g., FIG. 2). Due to the specific form (or shape) of the venting channel 24, the venting gas stream primarily flows along the opposite longitudinal sides of the venting channel 24. An end plate 30 is arranged at the longitudinal end of the single unit venting and cooling device 20, and the end plate 30 closes the venting channel 24 at that end as can be seen in, for example, FIG. 3. Two venting outlets 32 are provided extending through the inner profile 23 and the outer profile 25 near the longitudinal end of the venting channel 24 to allow the venting gas stream to exit the venting channel 24 in a direction perpendicular to the main flow direction M.

Further, an end cover element 34 is arranged at the longitudinal end of the single unit venting and cooling device 20, and the end cover element 34 covers the end plate 30 and the cooling channels 28 as can be seen in, for example, FIGS. 4 and 5. The end cover element 34 includes a supply line 36 for supplying cooling fluid to the cooling channels 28. The end plate 30 thereby prevents any cooling fluid from entering the venting channel 24.

The single unit venting and cooling device 20 actively cools the region around the venting channel 24, thereby cooling the venting gas stream flowing through the venting channel 24. As a result, the damaged cell that has experienced a thermal runaway is cooled but the venting gas stream is also significantly cooled before reaching the system outlet and leaving the battery system 100. Therefore, deflagration at the outlet of a battery housing of the battery system may be prevented. This reduces the risk of damage of external components and the risk of injury of any bystanders. The arrangement of the cooling channels surrounding the venting channel allows for uniform cooling of the venting device, for example, of the venting channel walls. Further, busbar cooling channels 28b are provided at the longitudinal sides of the single unit venting and cooling device 20 to cover and cool the busbars 16, thereby preventing thermal propagation from the damaged battery cell 12 to neighboring battery cell(s) 12 via the busbars 16.

Embodiments of the present disclosure provide a common venting channel for the battery cells to prevent contamination of the electrical connections of the battery system, for cooling of the venting gas to avoid deflagration, cooling of the top cell surface to prevent melt-down of the top cell surface, temperature reduction of the hottest area of the damaged cell, which is near the venting device, and cooling of the busbars for more efficient emergency cooling.

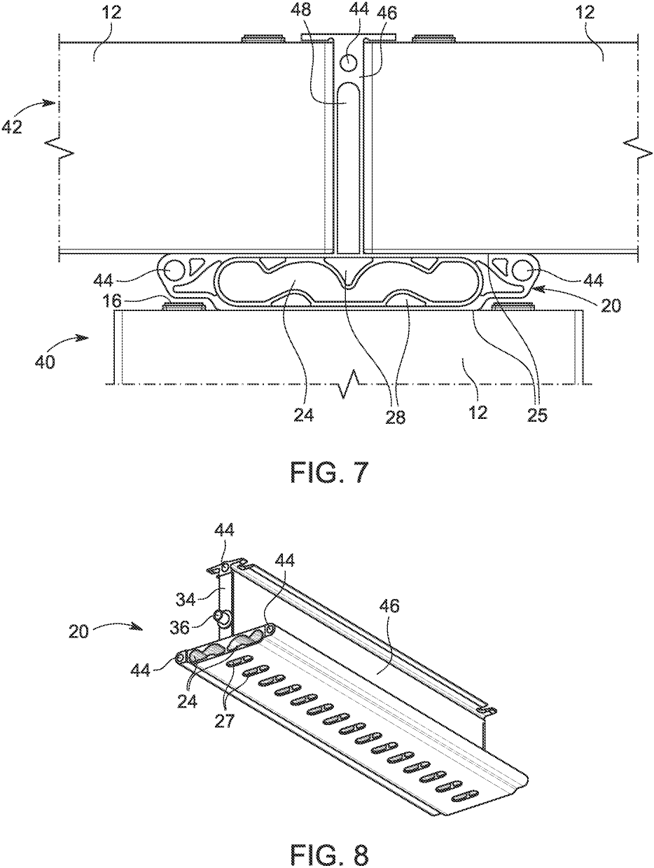

The single unit venting and cooling device 20 may be modified to act as bottom/top and/or side cooler in a multi floor design. Such an embodiment is shown in, for example, FIG. 7. Referring to FIG. 7, the plurality of battery cells 12 are arranged in multiple layers of battery cells stacked on one another including a lower layer 40 and an upper layer 42. The single unit venting and cooling device 20 is arranged between the lower layer 40 and the upper layer 42, and the outer profile 25 of the single unit venting and cooling device 20 is in thermal contact with both layers 40, 42. The venting channel 24 may be connected to the venting exits of at least one of the lower layer 40 and the upper layer 42 and, in some embodiments, may be connected with both. Thus, both the battery cells 12 of the upper layer 42 and of the lower layer 40 may vent into the same venting channel 24. Accordingly, the battery cells 12 of the upper layer 42 may include venting exits at their lower side, and the battery cells 12 of the lower layer 40 may include venting exits at their upper side.

A separator element 46 including a cooling channel 48 extends vertically from the single unit venting and cooling device 20, and the separator element 46 extends into a gap between two adjacent battery cells 12 of the upper layer 42 to separate these battery cells as can be seen in, for example, FIG. 7. The separator element 46 separates and cools the neighboring cells 12 of the upper layer 42 due to the cooling fluid flowing along the cooling channel 48 of the separator element 46. According to this embodiment, the single unit venting and cooling device 20 is modified to simultaneously cool battery cells above and below in a multi floor design.

In this embodiment, the single unit venting and cooling device 20 has mounting holes (e.g., mounting openings) 44 for structural integration of the single unit venting and cooling device 20 in the battery system/housing. The mounting holes 44 may also be provided with the single unit venting and cooling device according to an embodiment. The separator element 46 may include a mounting hole 44 as well.

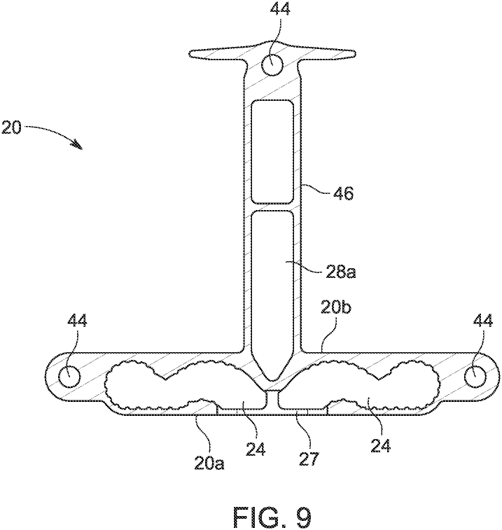

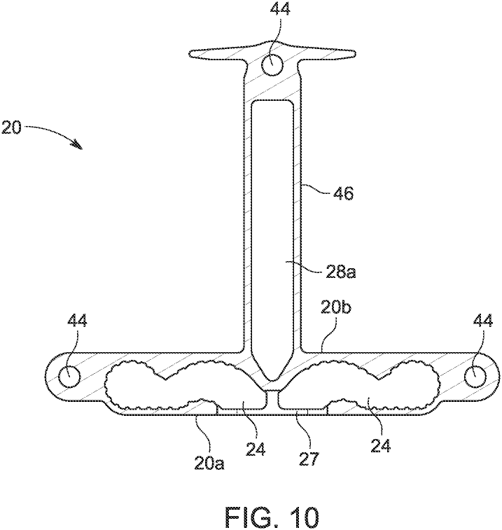

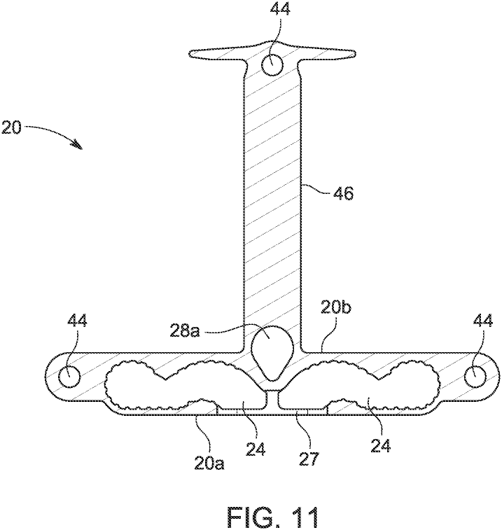

Instead of multiple cooling channels, only one cooling channel 28a may be provided as shown in the embodiments of FIGS. 8 to 11. In such embodiments, the single unit venting and cooling device 20 includes one cooling channel 28a arranged at the second side 20b of the single unit venting and cooling device 20, for example, opposite the venting openings 27. The cooling channel 28a may extend to a different extent into the separation member 46, thus, providing fluid domains of different volumes as shown in FIGS. 9 to 11.

The single unit venting and cooling device 20 of such embodiments is formed as one-piece as an extrusion profile. The end cover 34 is materially bonded to the profile as can be seen in, for example, FIG. 8. Further, the venting channel 24 may be split in two parts, both of which are accessible for the venting gas stream via the venting openings 27.

The side of the cell(s) of the upper layer 42 facing the cooled venting channel 24 (e.g., the top side of venting channel 24 in FIGS. 8 to 11) can be cooled via thermal conduction paths in the component to the fluid channel, which are realized by a central web in the extrusion profile where the extrusion profile has been subsequently milled away to form openings for the venting gas streams exiting the venting exits of the upper layer 42.

SOME REFERENCE SIGNS

| | |
|---|---|
| 10 | battery system |
| 12 | battery cells |
| 13 | venting exits |
| 14 | electrode terminals |
| 16 | busbars |
| 20 | single unit venting and cooling device |
| 20 a | first side of single unit venting and cooling device |
| 20 b | second side of single unit venting and cooling device |
| 22 | venting device |
| 23 | inner profile |
| 24 | venting channel |
| 25 | outer profile |
| 26 | cooling device |
| 27 | venting openings |
| 28 | cooling channels |
| 29 | grooves |
| 30 | end plate |
| 32 | venting outlets |
| 34 | end cover element |
| 36 | supply line |
| 40 | lower layer of battery cells |
| 42 | upper layer of battery cells |
| 44 | mounting holes |
| 46 | separator element |
| 48 | cooling channel |

What is claimed is:

1. A battery system comprising:
a battery pack comprising a plurality of battery cells;
a venting device configured to guide a venting gas stream exhausted by one or more of the battery cells away therefrom, the venting device comprising:
a venting channel configured to guide the venting gas stream along a main flow direction, the venting channel being delimited by a first side of the venting device and a second side of the venting device opposite the first side; and
a venting opening in the first side of the venting device to allow venting gases to enter the venting channel; and
a cooling device comprising a first cooling channel configured to cool the venting channel via a cooling fluid flowing through the first cooling channel, the first cooling channel being at the first side of the venting device.

2. The battery system according to claim 1, wherein the cooling device further comprises a second cooling channel at the second side of the venting device on an opposite side of the venting channel with respect to the first cooling channel for cooling the venting channel via a cooling fluid flowing through the second cooling channel.

3. The battery system according to claim 2, wherein the venting device and the cooling device are integrally formed.

4. The battery system according to claim 3, wherein the venting device and the cooling device are an extrusion profile.

5. The battery system according to claim 3, further comprising an end plate at a longitudinal end of the integral venting and cooling device, the end plate closing the venting channel,
wherein a venting outlet is in a channel wall of the venting channel adjacent the longitudinal end of the venting channel to allow the venting gas stream to exit the venting channel in a direction perpendicular to the main flow direction.

6. The battery system according to claim 5, further comprising an end cover element at the longitudinal end of the integral venting and cooling device, the end cover element covering the end plate and the first and second cooling channels,
wherein the end cover element is configured to allow supply of cooling fluid to the first and second cooling channels.

7. The battery system according to claim 2, wherein the cooling device further comprises two first cooling channels extending along the first side of the venting device, and
wherein the venting opening is between the two first cooling channels.

8. The battery system according to claim 2, wherein one or more of the first and second cooling channels protrude into the venting channel.

9. The battery system according claim 8, wherein the cooling device comprises a gas splitting projection inside the venting channel opposite the venting opening, the gas splitting projection being configured to split the gas stream entering the venting channel through the venting opening such that the gas stream is deflected to opposite sides of the venting channel.

10. The battery system according to claim 2, wherein the battery system comprises busbars interconnecting the battery cells via their terminals, and
wherein the busbars are thermally connected to the cooling device.

11. The battery system according to claim 10, wherein the cooling device further comprises two busbar cooling channels at opposite longitudinal sides of the venting channel, the busbar cooling channels being thermally connected to the busbars, respectively.

12. The battery system according to claim 1, wherein the plurality of battery cells are arranged in first and second layers of battery cells stacked on one another,
wherein the venting channel is between the first and second layers of battery cells,
wherein the venting channel is fluidly connected to the venting exits of at least one battery cell in each of the first and second layers of battery cells, and
wherein the first side of the venting device is in thermal contact with the battery cells in the first layer of battery cells, and the second side of the venting device is in thermal contact with the battery cells in the second layer of battery cells.

13. The battery system according to claim 12, wherein the venting device further comprises a separator element comprising a cooling channel extending vertically between two adjacent ones of the battery cells in the second layer of battery cells.

14. An electric vehicle comprising the battery system according to claim 1.

15. An integrated venting and cooling device comprising:
a venting channel for guiding a venting gas stream, the venting channel being delimited by a first side of the integrated venting and cooling device and a second side of the integrated venting and cooling device opposite the first side;
a venting opening in the first side of the integrated venting and cooling device for allowing venting gases to enter the venting channel; and
a cooling channel for cooling the venting channel via cooling fluid flowing through the cooling channel, the cooling channel being arranged at the second side of the integrated venting and cooling device.
